(19) United States
(12) Patent Application Publication
(10) Pub. No.: US 2004/0219414 A1
(43) Pub. Date: Nov. 4, 2004

(54) Cell unit having two types of fuel cells, electronic apparatus having fuel cell, and providing method of electric power

(75) Inventor: Akihiro Ozeki, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/393,862

(22) Filed: Mar. 22, 2003

(30) Foreign Application Priority Data
Sep. 30, 2002 (JP) JP2002-287890

(51) Int. Cl. H01M 8/24; H01M 8/04; H01M 16/00

(52) U.S. Cl. 429/34; 429/23; 429/9; 429/13

(57) ABSTRACT

An electronic apparatus has a first fuel cell capable of generating first electric power, a second fuel cell capable of generating second electric power less than the first electric power, a switching circuit coupled to the first fuel cell and the second fuel cell, and an electronic device coupled to the switching circuit. The electronic device is operable with one of the first electric power and the second electric power, depending on the electric power demand of the electric device.

### CROSS-REFERENCE TO RELATED APPLICATIONS

This application is based upon and claims the benefit of priority from Japanese Patent Application No. 2002-287890, filed Sep. 30, 2002, the entire contents of which are incorporated herein by reference.

### BACKGROUND OF THE INVENTION

1. Field of the Invention

This invention relates to a fuel cell for generating electric power, and also an electronic apparatus, such as a portable computer, which incorporates the fuel cell.

2. Description of the Related Art

In these years, various kinds of electronic devices that can be driven by batteries, such as a mobile information terminal called a Personal Digital Assistant (hereinafter PDA), a personal (mobile) computer, and a digital camera, have been developed and widely used.

On the other hand, in recent years, special attention has been focused upon environmental problems, and eco-friendly batteries have been actively developed. A direct methanol fuel cell (hereinafter DMFC) is well known as a battery of this kind.

In the DMFC, methanol and oxygen, which are supplied as fuel components, are subjected to a chemical reaction, and electric energy is obtained by the chemical reaction. An electrolyte is interposed between two electrodes formed of porous metal or carbon. See, “NENRYO DENCHI NO SUBETE” (“ALL ABOUT FUEL CELLS”), Hironosuke IKEDA, Kabushiki-Kaisha Nihon Jitsugyo Shuppansha, Aug. 20, 2001, pp. 216-217 incorporated herein by reference. There is a strong demand for practical use of the DMFC, since it produces no harmful waste.

In order to increase an output power per volume of the DMFC, an auxiliary mechanism (hereinafter auxiliary) such as a pump is required. In this specification, a DMFC using an auxiliary is referred to as “auxiliary-type DMFC”, and a DMFC using no auxiliary is referred to as “vaporization-type DMFC.”

In the meantime, most of mobile information terminals (e.g. laptop computer) have a suspend function or mode for retaining operating state parameters effective immediately before switch-off. The operating state parameter retained typically in a non-volatile memory (e.g. hard disk for a personal computer) and may be used to quickly resume the operating state when power is turned on. This enables quick resumption of the previous work when power is turned on.

Assume that an auxiliary-type DMFC is applied to a mobile information terminal having the suspend function, and that the suspend function is activated. In an ordinary mobile information terminal, about 200 to 300 mW power is consumed in the suspend mode in order to retain the state at the time of switch-off. On the other hand, the auxiliary-type DMFC consumes, in general, about 1 W power for operations of the auxiliary. In short, it is not desirable in terms of fuel consumption efficiency to activate the auxiliary that consumes about 1 W power in order to supply power is of about 200 to 300 mW.

Besides, in some kinds of devices, even when power is off, a power of about 60 to 70 mW needs to be supplied to internal circuits such as a microcomputer. In this case, the fuel consumption efficiency further deteriorates. Moreover, the auxiliary such as a pump produces some noise, and it is preferable to not operate the auxiliary in the suspend mode or when power is off.

### BRIEF SUMMARY OF THE INVENTION

Embodiments of the present invention provide an electronic apparatus accompanying a fuel cell unit which supplies with electric power.

According to an embodiment of the present invention, an electronic apparatus includes a first fuel cell for generating first electric power, a second fuel cell for generating second electric power less than the first electric power, a switching circuit coupled to the first fuel cell and the second fuel cell for selecting one of the first and second fuel cells, an electronic device coupled to the switching circuit, and a control circuit which is responsive to signals from the electronic device indicative of the power demand for controlling the switching circuit. The electronic device is operable with one of the first electric power and the second electric power, in responsive to electric power demand of the electric device.

According to other embodiments of the present invention, an electronic apparatus includes a first fuel cell for generating electric power using an auxiliary mechanism for fuel supply, a second fuel cell for generating electric power without the auxiliary mechanism, a switching circuit coupled to the first fuel cell and the second fuel cell for selecting one of the first and second fuel cells, and an electronic device coupled to the switching circuit. The electronic device is operable with the electric power provided from one of the first fuel cell and the second fuel cell.

According to further embodiments of the present invention, a method is provided for providing an electronic apparatus with electric power from fuel cells. In one embodiment, the method includes providing the electronic apparatus with electric power from a first fuel cell when the electronic apparatus is in first state requiring first electric power, the first fuel cell having an auxiliary mechanism for fuel supply, and providing the electronic apparatus with electric power from a second fuel cell capable of generating less electric power than that of the first fuel cell when the electronic apparatus is in second state requiring second electric power being lower than the first electric power.

Additional features and advantages of embodiments of the present invention will be set forth in the description which follows, and in part will be obvious from the description, or may be learned by practice of the invention.

The features and advantages of embodiments of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable personal computer according to a first embodiment of the present invention;

FIG. 2 is a block diagram showing a hardware configuration of a fuel cell unit in the portable personal computer according to the first embodiment;

FIG. 3 is a flowchart showing an operation control procedure for the fuel cell unit according to the first embodiment; and

FIG. 4 is a block diagram showing a hardware configuration of a fuel cell unit according to a second embodiment of the present invention.

### DETAILED DESCRIPTION

Preferred embodiments according to the present invention will be described hereinafter with reference to the accompanying drawings.

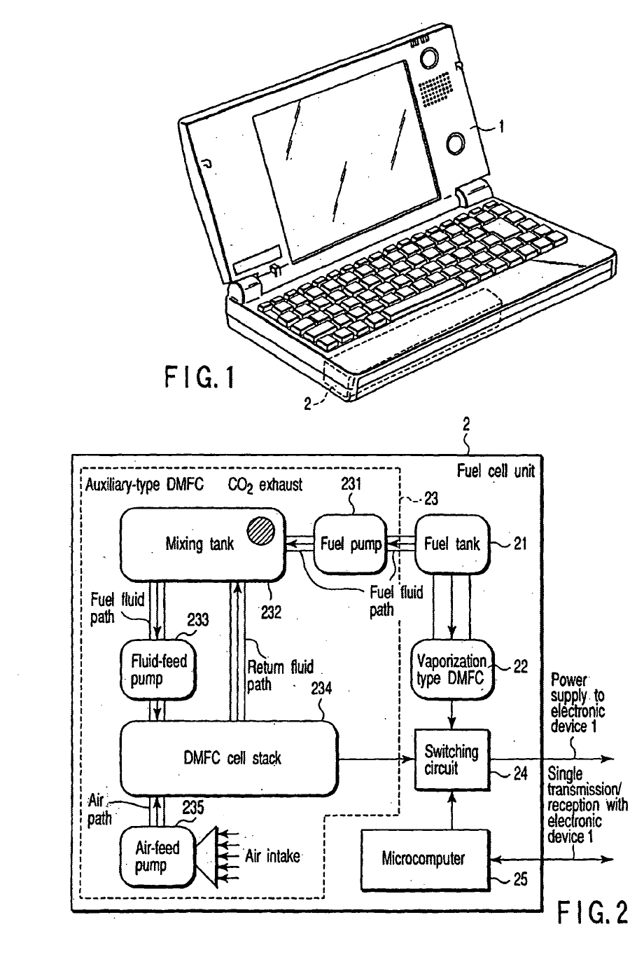

FIG. 1 shows an external appearance of an electronic apparatus according to a first embodiment of the present invention.

As is shown in FIG. 1, an electronic apparatus 1 of this embodiment is a portable personal computer. A fuel cell unit 2 is accommodated within a main body of the electronic apparatus 1. The fuel cell unit 2 supplies the electronic apparatus 1 with electric power, and the electronic apparatus 1 operates with the electric power. The fuel cell unit 2 is designed to be easily detachable and replaceable with a new fuel cell or the same fuel cell after refilling the fuel.

The electronic apparatus 1 has a suspend function for retaining parameters of an operating state which occurs immediately before turn-off of a power switch. Thereby, when the power switch is turned on, the previous work that has been suspended is displayed and may be quickly resumed. Accordingly, even in the suspend mode, the fuel cell unit 2 supplies the electronic apparatus 1 with electric power. In addition, in order to keep operations of internal circuits of a microcomputer, etc., the fuel cell unit 2 provides the electronic apparatus 1 with electric power even when the power switch is turned off. The power consumption of the electronic apparatus 1 in this embodiment is about 3 to 20 W in the power-on state, about 200 to 300 mW in the suspend state, and about 60 to 70 mW in the power-off state.

FIG. 2 shows a schematic structure of the fuel cell unit 2.

As shown in FIG. 2, the fuel cell unit 2 includes a fuel tank 21, a vaporization-type DMFC 22, an auxiliary-type DMFC 23, a switching circuit 24 and a microcomputer 25.

The fuel tank 21 is a cartridge type container that contains methanol to be used as fuel by the vaporization-type DMFC 22 and auxiliary-type DMFC 23. The fuel tank 21 is detachably disposed within the fuel cell unit 2 to permit replacement and/or refueling of it.

The vaporization-type DMFC 22 is a DMFC of the type wherein methanol supplied from the fuel tank 21 is vaporized therein and caused to react with oxygen in the air. Although the output power per volume is small in the vaporization-type DMFC 22, there is no power consumption by an auxiliary such as one or more pumps. On the other hand, the auxiliary-type DMFC 23 is a DMFC of the type wherein methanol in the fuel tank 21 and air are positively taken in by an auxiliary such as one or more pumps. Although the output power per volume is large in the auxiliary-type DMFC 23, power consumption due to the auxiliary is incurred. In this embodiment, the output power of the vaporization-type DMFC 22 is about 300 mW, the output power of the auxiliary-type DMFC 23 is about 20 W, and the power consumption of the auxiliary used in the auxiliary-type DMFC 23 is about 1 W.

The auxiliary-type DMFC 23 has a fuel pump 231, a mixing tank 232, a fluid-feed pump 233, a DMFC cell stack 234 and an air-feed pump 235. The auxiliary (or auxiliary mechanism) includes one or more of pumps 231, 233, and 235.

Methanol in the fuel tank 21 is fed into the mixing tank 232 by the fuel pump 231 and vaporized therein. The vaporized methanol is fed to the DMFC cell stack 234 by the fluid-feed pump 233. Air is fed to the DMFC cell stack 234 by the air-feed pump 235. The oxygen in the air and the vaporized methanol react with each other to generate electric power. Specifically, the above-mentioned power consumption of about 1 W by the auxiliary is the power consumption by the fuel pump 231, the fluid-feed pump 233, and the air-feed pump 235.

The switching circuit 24 is a selector for selectively supplying either an output power from the vaporization-type DMFC 22 or an output power from the auxiliary-type DMFC 23 to the electronic apparatus 1. The microcomputer 25 controls all operations of the fuel cell unit 2, including the operation of the switching circuit 24. The microcomputer 25 executes transmission/reception of various signals with the electronic apparatus 1.

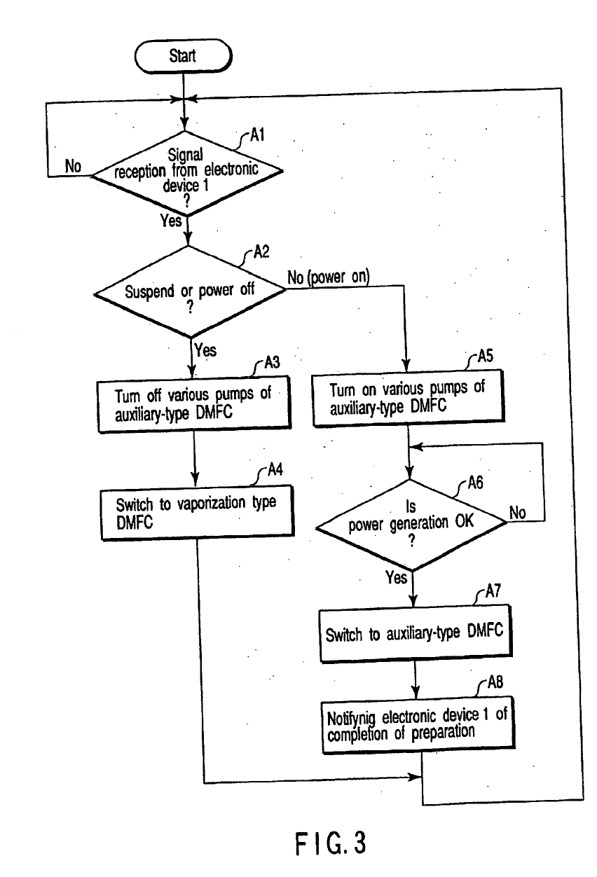

Referring to FIG. 3, the principle of the operational control of the fuel cell unit 2 will now be described.

The microcomputer 25 always monitors reception of a signal sent from the electronic apparatus 1 (step A1). If the microcomputer 25 has received a signal (YES in step A1), it determines whether the received signal is a signal indicative of the shift to the suspend mode or a signal indicative of the shift to power-off (step A2). If the signal is indicative of the shift to the suspend mode or power-off (YES in step A2), the microcomputer 25 turns off the respective pumps of the auxiliary-type DMFC 23 so as to stop fuel supply from the fuel tank 21 (step A3). Then, the microcomputer 25 operates the switching circuit 24 so as to feed an output power from the vaporization-type DMFC 22 to the electronic apparatus 1 (step A4).

On the other hand, if the received signal from the electronic apparatus 1 does not indicate a suspend mode or power off mode (i.e. power on mode) (NO in step A2), the microcomputer 25 detects that the electronic apparatus is in power-on state, and turns on the respective pumps of the auxiliary-type DMFC 23 (step A5). Thus, the electronic apparatus 1 sends signals to the microcomputer 25 indicative of the power demands of the electronic apparatus 1. The microcomputer 25 stands by until the auxiliary-type DMFC 23 has become ready to supply a predetermined amount of power (step A6). If the auxiliary-type DMFC 23 has become ready to supply the power (YES in step A6), the microcomputer 25 operates the switching circuit 24 so as to feed an output power from the auxiliary-type DMFC 23 to the electronic apparatus 1 (step A7) and informs the electronic device 1 of the completion of preparation for power-on (step A8).

As described above, in the fuel cell unit 2, the auxiliary-type DMFC 23 with the output power of about 20 W is used in the power-on state in which power of about 3 to 20 W is consumed. On the other hand, in the power-off state in which power of about 60 to 70 mW is consumed or in the suspend mode in which power of about 200 to 300 mW is consumed, the vaporization-type DMFC 22 with the output power of about 300 mW is used. This operational control realizes an improvement in fuel consumption efficiency and prevents noise from occurring due to the auxiliary in the suspend mode or in the power-off state.

When the auxiliary-type DMFC 23 is activated, the microcomputer 25 first operates the fuel pump 231, fluid-feed pump 233 and air-feed pump 235 using an output power of about 300 mW from the vaporization-type DMFC 22. After the auxiliary-type DMFC 23 has begun to generate a power of, e.g. 1 W or more, the microcomputer 25 then operates the fuel pump 231, fluid-feed pump 233 and air-feed pump 235 using an output power from the auxiliary-type DMFC 23. In the power-off state or in the suspend mode, the microcomputer 25 is supplied with power from the vaporization-type DMFC 22.

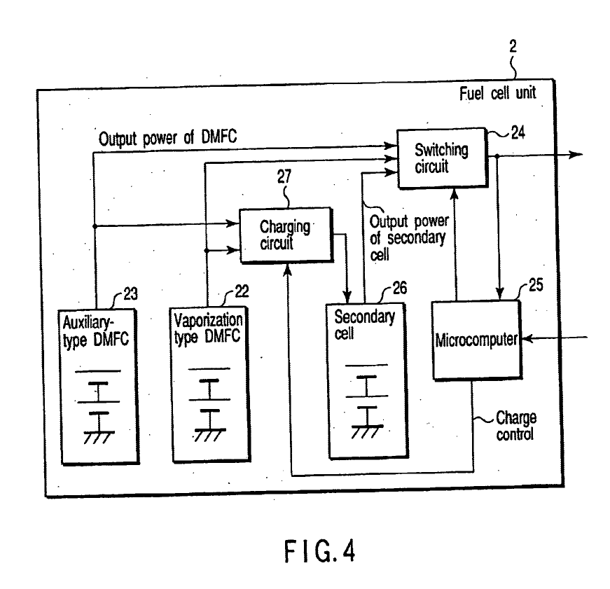

FIG. 4 shows the second embodiment of the present invention. The fuel cell unit 2 of the second embodiment differs from that of the first embodiment in that a secondary cell 26 (e.g. a battery, capacitor) and a charging circuit 27 for charging the secondary cell are added to the fuel cell unit 2. The switching circuit 24 carries out switching among the vaporization-type DMFC 22, the auxiliary-type DMFC 23, and the secondary cell 26.

In the second embodiment, the switching circuit 24 does not exclusively select only one of these three power supplies. Where necessary, power of the secondary cell 26 is added to the auxiliary-type DMFC 23 (e.g. the switching circuit 24 selects both the secondary cell 26 and the auxiliary-type DMFC 23).

The fuel cell unit 2 of the second embodiment is advantageously used in an electronic apparatus 1 wherein power consumption may suddenly be increased. The secondary cell 26 can supply a power, which is needed in the electronic apparatus but may not completely be supplied from the auxiliary-type DMFC 23 or which is instantaneously required in the electronic apparatus.

Besides, the charging circuit 27 charges the secondary cell 26 with an excess power of the vaporization-type DMFC 22 in the power-off state. Therefore, the fuel consumption efficiency is improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus, comprising:
a first fuel cell for generating electric power using an auxiliary mechanism for fuel supply;
a second fuel cell for generating electric power without the auxiliary mechanism;
a switching circuit coupled to said first fuel cell and said second fuel cell for selecting one of said first and second fuel cells; and
an electronic device coupled to said switching circuit, the electronic device being operable with the electric power provided from the selected one of said first fuel cell and said second fuel cell.

2. An electronic apparatus according to claim 1, wherein said electronic device is operable for changing a mode into a suspend mode for retaining parameter defining an operating state immediately before a power-off operation, and
said switching circuit provides said electronic device with the electric power provided from said second fuel cell when said electronic device is in one of the suspend mode and a state consuming less power than the suspend mode.

3. An electronic apparatus according to claim 2, wherein the auxiliary mechanism stops the fuel supply within said first fuel cell while said second fuel cell supplies said electronic device with the electric power.

4. An electronic apparatus according to claim 2, further comprising a microcomputer coupled to said electronic device and said switching circuit, wherein said microcomputer controls said switching circuit so as to provide said electronic device with the electric power provided from said first fuel cell when said microcomputer receives a signal from said electronic device indicative of a power-on state of said electronic device.

5. An electronic apparatus according to claim 4, wherein the microcomputer is operable for informing the electronic device of availability of power supply from the first fuel cell when the first fuel cell is ready to supply the power, after the microcomputer has been received the signal.

6. An electronic apparatus according to claim 1, wherein the auxiliary mechanism operates with the electric power from said second fuel cell at a time of initial use of said first fuel cell, and then operates with the electric power from said first fuel cell while said first fuel cell provides said electronic device with the electric power.

7. An electronic apparatus according to claim 1, further comprising a control circuit couple to said switching circuit for controlling the selection of said first fuel cell and said second fuel cell, said control circuit is responsive to signals received from said electronic device.

8. An electronic apparatus according to claim 7, further comprising a secondary cell coupled to said switching circuit, and the control circuit supplements electric power by using the secondary cell when electric power consumed by the electric device exceeds electric power capable of being supplied by the selected one of said first fuel cell and said second fuel cell.

9. An electronic apparatus according to claim 8, further comprising means for charging said secondary cell with electric power from at least one of the first fuel cell and the second fuel cell.

10. An electronic apparatus, comprising:
a first fuel cell for generating first electric power;
a second fuel cell for generating second electric power less than the first electric power;
a switching circuit coupled to said first fuel cell and said second fuel cell;
an electronic device coupled to the switching circuit, said electronic device being operable with one of the first electric power and the second electric power, in response to electric power demand of said electric device; and
a control circuit which is responsive to signals from said electronic device indicative of the power demand, for controlling the switching circuit.

11. An electronic apparatus according to claim 10, wherein said first fuel cell is an auxiliary-type direct methanol fuel cell.

12. An electronic apparatus according to claim 10, wherein said second fuel cell is a vaporization-type direct methanol fuel cell.

13. An electronic apparatus, comprising:
a first fuel cell for generating first electric power, said first fuel cell consuming a predetermined electric power in operation thereof;
a second fuel cell for generating second electric power less than the first electric power;
a switching circuit coupled to said first fuel cell and said second fuel cell; and
an electronic device coupled to said switching circuit, said electronic device being operable with one of the first electric power and the second electric power, depending on the electric demand of said electric device.

14. An electronic apparatus according to claim 13, wherein the electronic device is operable with the first electric power when the electric device consumes more than the predetermined electric power.

15. An electronic apparatus according to claim 13, wherein said electronic device is operable with the second electric power when said electric device consumes less than the predetermined electric power.

16. A cell unit, comprising:
a first fuel cell for generating electric power using an auxiliary mechanism for fuel supply;
a second fuel cell for generating electric power without the auxiliary mechanism; and
a switching circuit coupled to said first fuel cell and said second fuel cell, said switching circuit outputting electric power provided from one of said first fuel cell and said second fuel cell.

17. A cell unit according to claim 16, wherein the auxiliary mechanism operates with the electric power from said second fuel cell at that time of starting use of said first fuel cell.

18. A cell unit according to claim 16, further comprising a secondary cell which supplementary supplies electric power.

19. A cell unit according to claim 18, further comprising means for charging the secondary cell with electric power from at least one of said first fuel cell and said second fuel cell.

20. A method for providing an electronic apparatus with electric power from fuel cells, comprising the steps of:
providing the electronic apparatus with electric power from a first fuel cell when the electronic apparatus is in first state requiring first electric power, the first fuel cell having an auxiliary mechanism for fuel supply; and
providing the electronic apparatus with electric power from a second fuel cell capable of generating less electric power than that of the first fuel cell when the electronic apparatus is in second state requiring second electric power which is less than the first electric power.

21. A method according to claim 20, wherein the second state is a suspend mode of the electronic apparatus.

22. A method according to claim 20, wherein the second state is power-off state.

23. A method according to claim 20, further comprising:
detecting that the electronic apparatus is in a power-on state; and
switching the provision of electric power from the second fuel cell to the first fuel cell.

24. A method according to claim 23, further comprising informing the electronic apparatus that the first fuel cell may be used for supplying the first power.
